(19) United States
(12) Patent Application Publication
(10) Pub. No.: US 2006/0153048 A1
(43) Pub. Date: Jul. 13, 2006

(54) PROTECTION WINDOW SIGNAL GENERATOR FOR HEADER DETECTION AND METHOD THEREOF

(76) Inventors: Kuo-Jung Lan, Taipei County (TW); Tzu-Ming Chou, Taipei County (TW); Chi-Pei Huang, Miaoli County (TW); Chih-Chung Wu, Ping-Tung County (TW); Kuang-Jung Chang, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/308,016

(22) Filed: Mar. 3, 2006

Related U.S. Application Data
(63) Continuation-in-part of application No. 10/904,031, filed on Oct. 20, 2004.

(30) Foreign Application Priority Data
Dec. 1, 2003 (TW) 092133753

(51) Int. Cl. G11B 7/00

(52) U.S. Cl. 369/124.07

(57) ABSTRACT

Methods and apparatuses for generating a protection window signal for use in header detection of an optical storage medium are disclosed. One of the methods involves: extracting a maximum level of an RF-sum signal derived from the optical storage medium to generate a first level value; extracting at least one of DC level and bottom level of the RF-sum signal to generate a corresponding second level value; calculating a reference level according to the first and second level values; and comparing the RF-sum signal with the reference level to determine a protection window signal. When the accessing of the optical storage medium is switched from a first area with a first reflectivity to a second area with a second reflectivity, the response speed of extracting the DC level/bottom level of the RF-sum signal, the weighting of the second level value, or the DC level of the RF-sum signal is adjusted.

### CROSS REFERENCE TO RELATED APPLICATIONS

This is a continuation-in-part of U.S. patent application Ser. No. 10/904,031, filed Oct. 20, 2004, and entitled “METHOD AND APPARATUS FOR HEADER DETECTION AND PROTECTION,” which is included herein by reference.

### BACKGROUND

The present disclosure relates to optical storage techniques, and more particularly, to protection window signal generators for detection of header regions of an optical storage medium and method thereof.

A DVD-RAM disc is capable of recording and deleting data freely. In the related art, the DVD-RAM disc comprises data sectors for use in recording data. Each data sector primarily includes a header region and a recording region, wherein the recording region is also referred to as a non-header region. The recording region is used for recording user data. The address and location information such as track and sector number are recorded in the header region. The header region is typically divided into two sub-regions, which are disposed adjacent to each other.

In practical applications, reliable detection of the header regions of the DVD-RAM disc is essential for controlling the rotation of the DVD-RAM disc and precisely retrieving information recorded on the header regions. Ideally, the waveform of a push-pull signal extracted from the DVD-RAM disc has a rapid change in the header region due to a high frequency signal of the header information recorded on the header region. Therefore, the conventional method being applied for detecting the header region of the DVD-RAM disc is to compare the push-pull signal with two different reference levels so as to generate two detection signals, which respectively correspond to the two sub-regions of the header region.

Unfortunately, erroneous detection signals are easily induced by the track slippage phenomenon, instability of the movement of the optical pick-up head, or other mechanical problems, thereby degrading the detection accuracy of the header region. A conventional method for improving the detection accuracy of the header region is to generate a protection window according to the RF-sum signal extracted from the DVD-RAM disc, and detection signals appearing outside the protection window are regarded as noise to reduce erroneous detection signals. In the related art, the protection window is produced by slicing the RF-sum signal according to a reference level, which is a mathematical combination of a maximum value and a low value extracted from the RF-sum signal.

In most applications, the DVD-RAM disc may simultaneously contain some sectors with recorded data and some blank sectors. The sectors with recorded data are referred to as data areas while the blank sectors are referred to as blank areas. However, since the reflectivity of the data area differs from the reflectivity of the blank area, the DC level of the RF-sum signal corresponding to the non-header region in a data area differs from that corresponding to the non-header region in a blank area. When the accessing of the DVD-RAM disc is switched from a data area to a blank area, the conventional technique may be unable to make sufficient adjustment of the low value (and the reference level calculated based on the low value) to reflect the actual change of DC level of the RF-sum signal. As a result, incorrect protection windows may be produced thereby degrading the detection accuracy of the header region.

Please refer to FIG. 7, which shows a timing diagram 700 illustrating the generation of protection window according to the related art. In FIG. 7, the accessing of the DVD-RAM disc is switched from a data area to a blank area at a time point 710. Typically, the reflectivity of the data area of the DVD-RAM disc is lower than the reflectivity of the blank area. Thus, the DC level of the RF-sum signal corresponding to the non-header region of the data area is lower than that corresponding to the non-header region of the blank area. As shown in FIG. 7, when the accessing operation is switched from the data area to the blank area, the adjustment of the low value made by the related art cannot keep up with the actual change of the DC level of the RF-sum signal. Accordingly, the reference level calculated based on the low value is increased slowly.

Because the reference level exceeds the level of the RF-sum signal at a time point 720, an incorrect protection window 702, which is much wider than other protection windows, is produced. As a result, the detections of the header regions HRₙ and HRₙ₊₁ are prone to errors due to detection signals and noise occurring within the protection window 702 cannot be differentiated.

### SUMMARY

An exemplary embodiment of a protection window signal generator for use in detection of a header region of an optical storage medium is disclosed. The protection window signal generator comprises: a first level extractor for extracting a maximum level of an RF-sum signal derived from the optical storage medium to generate a corresponding first level value; a second level extractor for extracting at least one of a DC level and a bottom level of the RF-sum signal to generate a corresponding second level value; a control unit, coupled to the second level extractor, for adjusting the response speed of the second level extractor when the accessing of the optical storage medium is switched from a first area with a first reflectivity to a second area with a second reflectivity; a computing device coupled to the first and second level extractors for calculating a reference level according to the first and second level values; and a comparing device coupled to the computing device for comparing the RF-sum signal with the reference level to determine a protection window signal applied to detection of the header region.

An exemplary embodiment of a method for generating a protection window signal for use in detection of a header region of an optical storage medium, the method comprising: extracting a maximum level of an RF-sum signal derived from the optical storage medium to generate a corresponding first level value; extracting at least one of a DC level and a bottom level of the RF-sum signal to generate a corresponding second level value; adjusting the response speed of extracting the DC level/bottom level when the accessing of the optical storage medium is switched from a first area with a first reflectivity to a second area with a second reflectivity; calculating a reference level according to the first and second level values; and comparing the RF-sum signal with the reference level to determine a protection window signal applied to detection of the header region.

Another exemplary embodiment of a protection window signal generator for use in detection of a header region of an optical storage medium is disclosed. The protection window signal generator comprises: a first level extractor for extracting a maximum level of an RF-sum signal derived from the optical storage medium to generate a corresponding first level value; a second level extractor for extracting at least one of a DC level and a bottom level of the RF-sum signal to generate a corresponding second level value; a computing device coupled to the first and second level extractors for weighted-blending of the first and second level values to generate a reference level in which the weighting of the second level value is increased when the accessing of the optical storage medium is switched from a first area with a first reflectivity to a second area with a second reflectivity; and a comparing device coupled to the computing device for comparing the RF-sum signal with the reference level to determine a protection window signal applied to detection of the header region.

Another exemplary embodiment of a method for generating a protection window signal for use in detection of a header region of an optical storage medium is disclosed, the method comprising: extracting a maximum level of an RF-sum signal derived from the optical storage medium to generate a corresponding first level value; extracting at least one of a DC level and a bottom level of the RF-sum signal to generate a corresponding second level value; performing a weighted-blending operation on the first and second level values to generate a reference level in which the weighting of the second level value is increased when the accessing of the optical storage medium is switched from a first area with a first reflectivity to a second area with a second reflectivity; and comparing the RF-sum signal with the reference level to determine a protection window signal applied to detection of the header region.

Another exemplary embodiment of a protection window signal generator for use in detection of a header region of an optical storage medium is disclosed. The protection window signal generator comprises: an adjusting device for adjusting DC level of an RF-sum signal derived from the optical storage medium when the accessing of the optical storage medium is switched from a first area with a first reflectivity to a second area with a second reflectivity so that the resulting RF-sum signal has substantially the same DC level with respect to both the first area and the second area; a first level extractor coupled to the adjusting device for extracting a maximum level of the adjusted RF-sum signal to generate a corresponding first level value; a second level extractor coupled to the adjusting device for extracting at least one of a DC level and a bottom level of the adjusted RF-sum signal to generate a corresponding second level value; a computing device coupled to the first and second level extractors for calculating a reference level according to the first and second level values; and a comparing device coupled to the computing device and the adjusting device for comparing the adjusted RF-sum signal with the reference level to determine a protection window signal applied to detection of the header region.

Another exemplary embodiment of a method for generating a protection window signal for use in detection of a header region of an optical storage medium is disclosed. The method comprises: adjusting DC level of an RF-sum signal derived from the optical storage medium when the accessing of the optical storage medium is switched from a first area with a first reflectivity to a second area with a second reflectivity so that the resulting RF-sum signal has substantially the same DC level with respect to both the first area and the second area; extracting a maximum level of the adjusted RF-sum signal to generate a corresponding first level value; extracting at least one of a DC level and a bottom level of the adjusted RF-sum signal to generate a corresponding second level value; calculating a reference level according to the first and second level values; and comparing the adjusted RF-sum signal with the reference level to determine a protection window signal applied to detection of the header region.

Another exemplary embodiment of a protection window signal generator for use in detection of a header region of an optical storage medium is disclosed. The protection window signal generator comprises: a first level extractor for extracting a maximum level of an RF-sum signal derived from the optical storage medium to generate a corresponding first level value; a second level extractor for extracting at least one of a DC level and a bottom level of the RF-sum signal to generate a corresponding second level value; a computing device coupled to the first and second level extractors for calculating a reference level according to the first and second level values; a comparing device coupled to the computing device and the adjusting device for comparing the RF-sum signal with the reference level to determine a protection window signal applied to detection of the header region; and means for adjusting at least one of the response speed of the second level extractor, the weighting of the second level value, and the DC level of the RF-sum signal when the accessing of the optical storage medium is switched from a first area with a first reflectivity to a second area with a second reflectivity.

Another exemplary embodiment of a method for generating a protection window signal for use in detection of a header region of an optical storage medium is disclosed. The method comprises: extracting a maximum level of an RF-sum signal derived from the optical storage medium to generate a corresponding first level value; extracting at least one of a DC level and a bottom level of the RF-sum signal to generate a corresponding second level value; calculating a reference level according to the first and second level values; comparing the RF-sum signal with the reference level to determine a protection window signal applied to detection of the header region; and adjusting at least one of the response speed of extracting the DC level/bottom level, the weighting of the second level value, and the DC level of the RF-sum signal when the accessing of the optical storage medium is switched from a first area with a first reflectivity to a second area with a second reflectivity.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a protection window signal generator for use in detection of a header region of an optical storage medium according to a first embodiment.

FIG. 2 is a timing diagram of the protection window signal generator of FIG. 1 according to an exemplary embodiment.

FIG. 3 is a functional block diagram of a protection window signal generator according to a second embodiment.

FIG. 4 is a timing diagram of the protection window signal generator of FIG. 3 according to an exemplary embodiment.

FIG. 5 is a functional block diagram of a protection window signal generator according to a third embodiment.

FIG. 6 is a timing diagram of the protection window signal generator of FIG. 5 according to an exemplary embodiment.

FIG. 7 is a timing diagram illustrating the generation of protection window according to the related art.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. In addition, the term “couple” is intended to mean either an indirect or a direct electrical connection. Accordingly, if one device is coupled to another device, that connection may be through a direct electrical connection, or through an indirect electrical connection via other devices and connections.

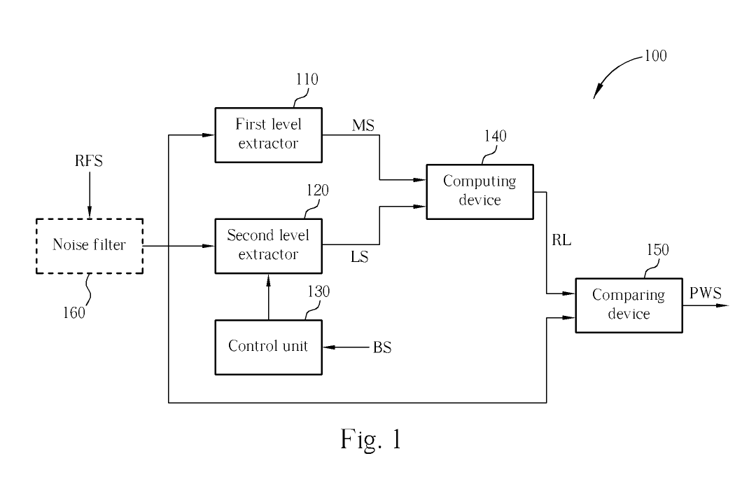

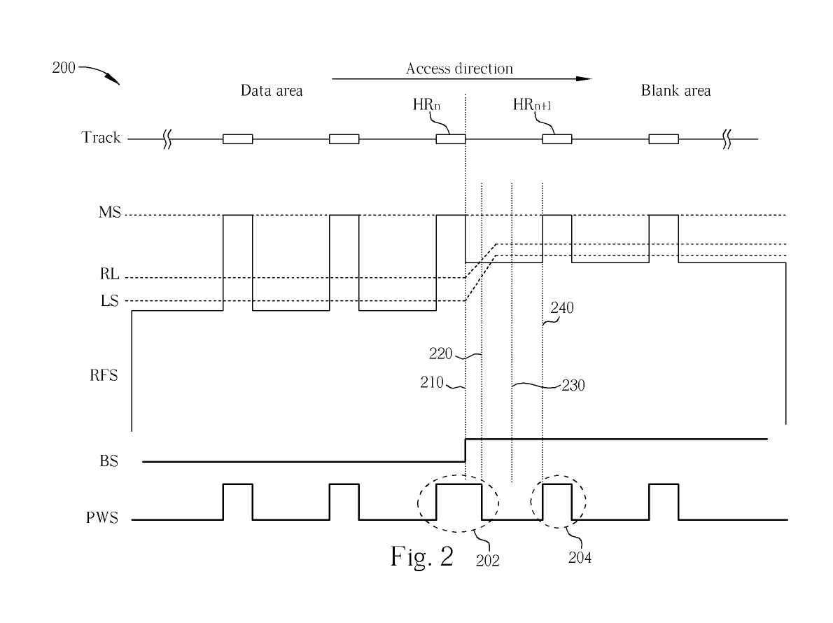

Please refer to FIG. 1, which shows a functional block diagram of a protection window signal generator 100 for use in detection of a header region of an optical storage medium according to a first embodiment. In this embodiment, the protection window signal generator 100 comprises a first level extractor 110, a second level extractor 120, a control unit 130 coupled to the second level extractor 120, a computing device 140 coupled to the first and second level extractors 110 and 120, and a comparing device 150 coupled to the computing device 140. For the purpose of explanatory convenience in the following description, the protection window signal generator 100 is hereinafter assumed to be for generating a protection window signal for use in detection of a header region of a DVD-RAM disc. Hereinafter, operations of the functional blocks of the protection window signal generator 100 will be described with reference to a timing diagram 200 shown in FIG. 2.

The first level extractor 110 is arranged for extracting a maximum level of an RF-sum signal RFS derived from the DVD-RAM disc to generate a corresponding first level value MS. The first level extractor 110 is implemented with a maximum value detector for detecting the maximum voltage level of the RF-sum signal RFS. In order to reduce the complexity of controlling the following stages, the first level extractor 110 of this embodiment is designed to saturate when the maximum voltage level of the RF-sum signal RFS exceeds a predetermined threshold. Accordingly, the first level value MS will be clamped in a predetermined value when the maximum voltage level of the RF-sum signal RFS exceeds the predetermined threshold as shown in FIG. 2.

The second level extractor 120 is arranged for extracting a DC level of the RF-sum signal RFS to generate a corresponding second level value LS. The control unit 130 is arranged for adjusting the response speed of the second level extractor 120 when the accessing of the DVD-RAM disc is switched from a first area with a first reflectivity to a second area with a second reflectivity. Specifically, when the accessing of the DVD-RAM disc is switched from an area with a relative lower reflectivity to another area with a relative higher reflectivity, the control unit 130 of this embodiment increases the response speed of the second level extractor 120. For example, the control unit 130 increases the response speed of the second level extractor 120 when the accessing of the DVD-RAM disc is switched from a data area to a blank area.

In a preferred embodiment, the control unit 130 increases the response speed of the second level extractor 120 when receiving a blank signal BS, which indicates the location of a blank area of the DVD-RAM disc. Since the generation of the blank signal BS is well known in the art, further details are omitted herein for the sake of brevity. In practice, the second level extractor 120 may be implemented with a low-pass filter, and the control unit 130 can increase the response speed of the low-pass filter by increasing its bandwidth. In practical applications, the second level extractor 120 may be implemented with a bottom hold circuit for extracting a bottom level of the RF-sum signal RFS to generate a corresponding second level value LS, and the first level extractor 110 may be implemented with a peak hold circuit for performing a peak hold operation on the RF-sum signal RFS to extract the maximum level of the RF-sum signal RFS.

In the protection window signal generator 100, the computing device 140 is arranged for calculating a reference level RL according to the first level value MS and the second level value LS. In practical implementations, the computing device 140 may perform a weighted-blending operation on the first level value MS and the second level value LS to generate the reference level RL. The comparing device 150 then compares the RF-sum signal RFS with the reference level RL to determine a protection window signal PWS for use in the detection of the header region of the DVD-RAM disc. The comparing device 150 may be a slicer for slicing the RF-sum signal RFS based on the reference level RL.

As shown in FIG. 2, the blank signal BS occurs at a time point 210. Accordingly, the control unit 130 increases the response speed of the second level extractor 120 for a predetermined period beginning from the time point 210. For example, the control unit 130 can increase the response speed of the second level extractor 120 within the period between the time points 210 and 230. After the time point 230, the response speed of the second level extractor 120 is adjusted to the original configuration by the control unit 130. As a result, the adjustment of the second level value LS made by the second level extractor 120 is able to quickly reflect the actual change of DC level of the RF-sum signal RFS. As shown, the second level value LS can reach a new stable state within the period at which the response speed of the second level extractor 120 is increased.

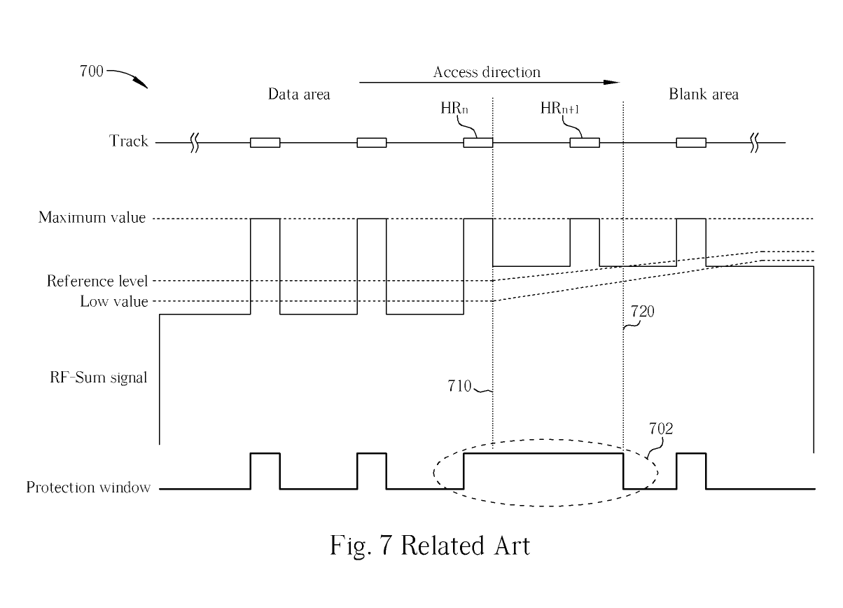

On the other hand, the reference level RL is also correspondingly changed with the second level value LS within the period between the time point 210 and 230 because it is calculated based on the second level value LS. In this embodiment, the reference level RL exceeds the voltage level of the RF-sum signal RFS at a time point 220, so the comparing device 150 switches the level of the protection window signal PWS at the time point 220 and results in a protection window 202. As shown, the period of the protection window 202 may be slightly longer than the other protection windows in the protection window signal PWS but it is much shorter than the conventional protection window 702 shown in FIG. 7. As in the foregoing illustrations, detection signals within the period of the protection window 202 are regarded as valid detection signals corresponding to a header region HRₙ, so the header region HRₙ can be accurately detected.

In addition, since the time point 220 is prior to a time point 240 at which the next header region HRₙ₊₁ begins, the protection window 202 does not overlap the next protection window 204. Thus, the next header region HRₙ₊₁ can also be accurately detected based on detection signals verified (or protected) by the protection window 204. As described above, pulses of the detection signals occurring in the interval between the protection windows 202 and 204 are regarded as noise, so detection accuracy of the header regions HRₙ₊₁ and HRₙ₊₁ is significantly improved in comparison with the related art.

In a preferred embodiment, as shown in FIG. 1, the protection window signal generator 100 is further provided with a noise filter 160 for performing a filtering operation on the RF-sum signal to be fed to the first level extractor 110, the second level extractor 120, and the comparing device 150 in order to reduce the noise in the RF-sum signal RFS. In practice, the noise filter 160 may be implemented with a low-pass filter.

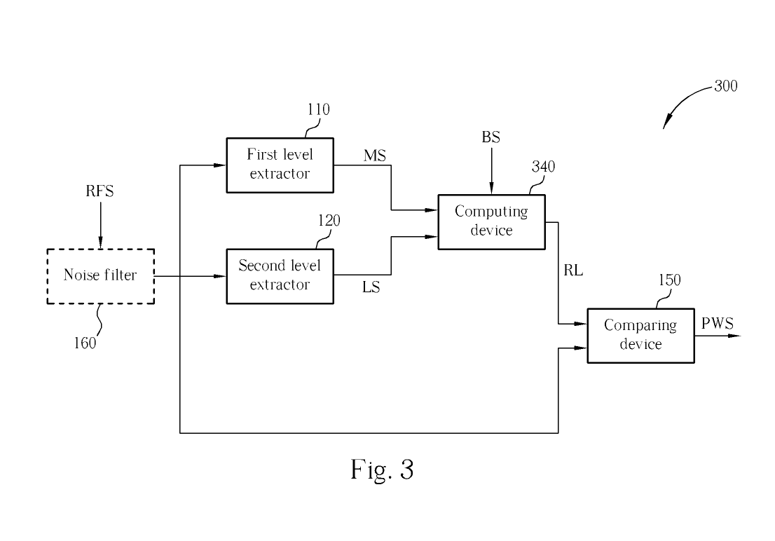

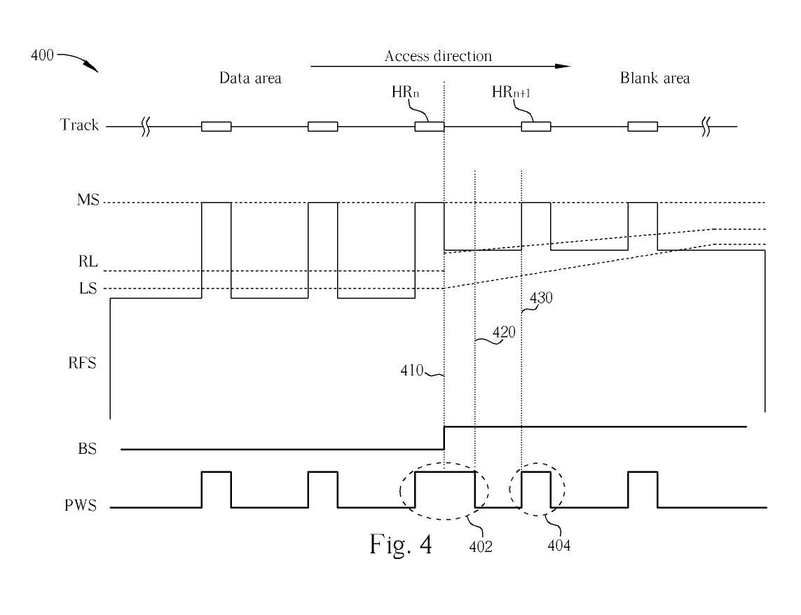

Please refer to FIG. 3 and FIG. 4. FIG. 3 illustrates a functional block diagram of a protection window signal generator 300 according to a second embodiment. FIG. 4 is a timing diagram 400 of the protection window signal generator 300 according to an exemplary embodiment. Most functional blocks of the protection window signal generator 300 are similar to that of the protection window signal generator 100, so functional blocks having the same operations and implementations are labeled the same for the sake of clarity. A difference between the protection window signal generators 100 and 300 is that the control unit 130 of FIG. 1 is omitted in the protection window signal generator 300. Another difference between the two embodiments is that a computing device 340 arranged in the protection window signal generator 300 adjusts the weighting of the second level value LS when the accessing of the DVD-RAM disc is switched from a data area to a blank area at a time point 410.

For example, suppose that the original weightings of the first level value MS and the second level value LS are respectively 0.8 and 0.2, the computing device 340 may respectively adjust the weightings of the first level value MS and the second level value LS to 0.45 and 0.55 when the accessing operation is switched from the data area to the blank area. As a result, the reference level RL calculated based on the first level value MS and the second level value LS can quickly increase in response to the actual change of the DC level of the RF-sum signal RFS. In the embodiment shown in FIG. 4, the reference level RL exceeds the level of the RF-sum signal RFS at a time point 420 before a time point 430 at which the header region HRₙ₊₁ begins, so the comparing device 150 switches the level of the protection window signal PWS at the time point 420 to produce a protection window 402 corresponding to the header region HRₙ.

Similar to the previous embodiment, the protection window 402 is much shorter than the conventional protection window 702 of the related art and is not overlap the next protection window 404 corresponding to the next header region HRₙ₊₁ beginning at the time point 430. Therefore, detection accuracy of the header regions HRₙ₊₁ and HRₙ₊₁ is significantly improved in comparison with the related art. In a preferred embodiment, the computing device 340 is designed to increase the weighting of the second level value LS when receiving a blank signal BS.

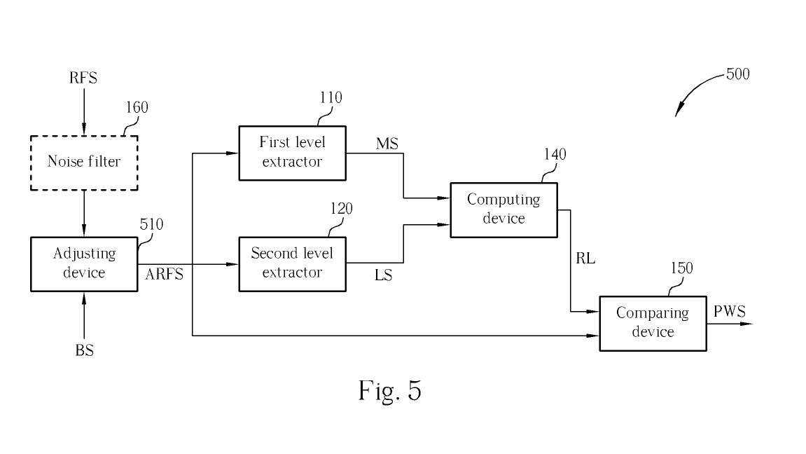

Please refer to FIG. 5, which shows a functional block diagram of a protection window signal generator 500 according to a third embodiment. In FIG. 5, functional blocks having the same operations and implementations as the previous embodiments are labeled the same for the sake of clarity. In this embodiment, the control unit 130 of FIG. 1 is omitted but an adjusting device 510 is added. The adjusting device 510 is arranged for adjusting the DC level of the RF-sum signal RFS when the accessing of the DVD-RAM disc is switched from a first area with a first reflectivity to a second area with a second reflectivity so that an adjusted RF-sum signal ARFS outputted from the adjusting device 510 has substantially the same DC level with respect to both the first area and the second area. For example, the adjusting device 510 may adjust the DC level of the RF-sum signal RFS when the accessing of the DVD-RAM disc is switched from a data area to a blank area in order to make the adjusted RF-sum signal to have substantially the same DC level in both the data area and the blank area.

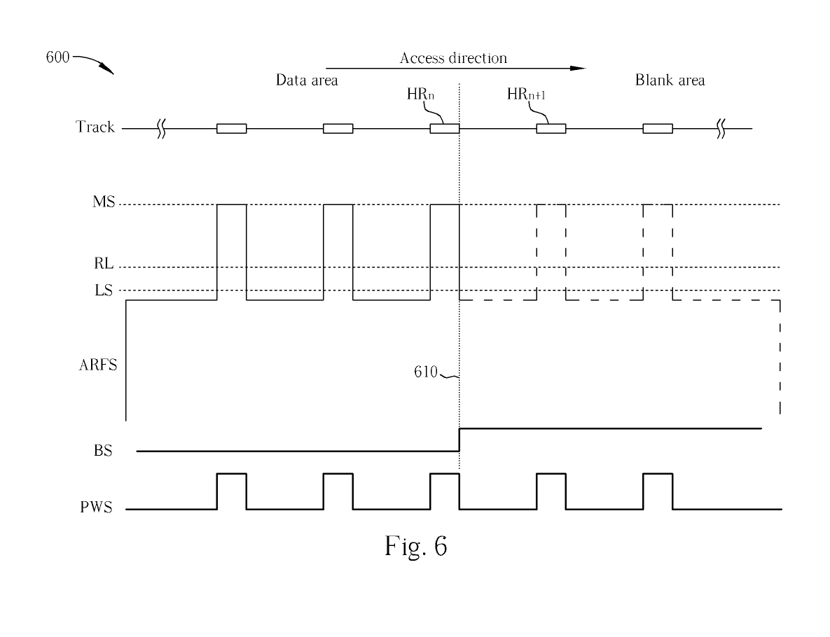

FIG. 6 shows a timing diagram 600 of the protection window signal generator 500 according to an exemplary embodiment. In FIG. 6, the dotted portion of the adjusted RF-sum signal ARFS represents the adjusted effect made by the adjusting device 510. As shown, since the adjusted RF-sum signal ARFS have the same DC level in both the data area and the blank area, it is not required to adjust the response speed of the second level extractor 120 or the weighting of the second level value LS. Similarly, the adjusting device 510 can start to adjust the DC level of the RF-sum signal RFS when receiving a blank signal BS beginning at a time point 610.

In practice, the adjusting device 510 may adjust the DC level of the RF-sum signal RFS by adjusting the gain or offset of the RF-sum signal RFS. Of course, the adjusting device 510 may adjust both the gain and offset of the RF-sum signal RFS when receiving the blank signal BS to achieve the same purpose. Additionally, the adjusting device 510 of this embodiment is arranged after the noise filter 160, this is merely an example rather than a restriction of the practical implementations. For example, the adjusting device 510 can also be arranged prior to the noise filter 160.

Please note that the features of the means for improving the correctness of the protection window signal described in this disclosure can be combined with each other to obtain similar effect. All of the disclosed mechanisms and features can be combined together to improve the performance.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A protection window signal generator for use in detection of a header region of an optical storage medium, the protection window signal generator comprising:
a first level extractor for extracting a maximum level of an RF-sum signal derived from the optical storage medium to generate a corresponding first level value;
a second level extractor for extracting at least one of a DC level and a bottom level of the RF-sum signal to generate a corresponding second level value;
a control unit, coupled to the second level extractor, for adjusting the response speed of the second level extractor when the accessing of the optical storage medium is switched from a first area with a first reflectivity to a second area with a second reflectivity;
a computing device coupled to the first and second level extractors for calculating a reference level according to the first and second level values; and
a comparing device coupled to the computing device for comparing the RF-sum signal with the reference level to determine a protection window signal applied to detection of the header region.

2. The protection window signal generator of claim 1, wherein the control unit increases the response speed of the second level extractor when the accessing of the optical storage medium is switched from the first area to the second area.

3. The protection window signal generator of claim 2, wherein the first area is an area with recorded data and the second area is a blank area.

4. The protection window signal generator of claim 2, wherein the second level extractor comprises at least one of a low-pass filter and a bottom hold circuit.

5. The protection window signal generator of claim 4, wherein the control unit increases the response speed of the low-pass filter by increasing the bandwidth of the low-pass filter.

6. The protection window signal generator of claim 2, wherein the control unit increases the response speed of the second level extractor when receiving a blank signal.

7. The protection window signal generator of claim 1, wherein the comparing device comprises a slicer.

8. The protection window signal generator of claim 1, wherein the first level extractor comprises a peak hold circuit.

9. A method for generating a protection window signal for use in detection of a header region of an optical storage medium, the method comprising:
(a) extracting a maximum level of an RF-sum signal derived from the optical storage medium to generate a corresponding first level value;
(b) extracting at least one of a DC level and a bottom level of the RF-sum signal to generate a corresponding second level value;
(c) adjusting the response speed of extracting the DC level/bottom level when the accessing of the optical storage medium is switched from a first area with a first reflectivity to a second area with a second reflectivity;
(d) calculating a reference level according to the first and second level values; and
(e) comparing the RF-sum signal with the reference level to determine a protection window signal applied to detection of the header region.

10. The method of claim 9, wherein the step (c) comprises:
increasing the response speed of extracting the DC level or the bottom level when the accessing of the optical storage medium is switched from the first area to the second area.

11. The method of claim 10, wherein the first area is an area with recorded data and the second area is a blank area.

12. The method of claim 10, wherein step (b) comprises:
performing at least one of a low-pass filtering operation and a bottom hold operation on the RF-sum signal to generate the second level value.

13. The method of claim 12, wherein step (c) comprises:
increasing the response speed of extracting the DC level by increasing the bandwidth of the low-pass filtering operation.

14. The method of claim 10, wherein step (c) comprises:
increasing the response speed of extracting the DC level or the bottom level when receiving a blank signal.

15. The method of claim 10, wherein step (e) comprises:
slicing the RF-sum signal according to the reference level to generate the protection window signal.

16. The method of claim 9, wherein step (a) comprises:
performing a peak hold operation on the RF-sum signal to extract the maximum level of the RF-sum signal.

17. A protection window signal generator for use in detection of a header region of an optical storage medium, the protection window signal generator comprising:
a first level extractor for extracting a maximum level of an RF-sum signal derived from the optical storage medium to generate a corresponding first level value;
a second level extractor for extracting at least one of a DC level and a bottom level of the RF-sum signal to generate a corresponding second level value;
a computing device coupled to the first and second level extractors for weighted-blending of the first and second level values to generate a reference level in which the weighting of the second level value is increased when the accessing of the optical storage medium is switched from a first area with a first reflectivity to a second area with a second reflectivity; and
a comparing device coupled to the computing device for comparing the RF-sum signal with the reference level to determine a protection window signal applied to detection of the header region.

18. The protection window signal generator of claim 17, wherein the first area is an area with recorded data and the second area is a blank area.

19. The protection window signal generator of claim 17, wherein the computing device increases the weighting of the second level value when receiving a blank signal.

20. A method for generating a protection window signal for use in detection of a header region of an optical storage medium, the method comprising:
(a) extracting a maximum level of an RF-sum signal derived from the optical storage medium to generate a corresponding first level value;
(b) extracting at least one of a DC level and a bottom level of the RF-sum signal to generate a corresponding second level value;
(c) performing a weighted-blending operation on the first and second level values to generate a reference level in which the weighting of the second level value is increased when the accessing of the optical storage medium is switched from a first area with a first reflectivity to a second area with a second reflectivity; and
(d) comparing the RF-sum signal with the reference level to determine a protection window signal applied to detection of the header region.

21. The method of claim 20, wherein the first area is an area with recorded data and the second area is a blank area.

22. The method of claim 20, wherein step (c) comprises:
increasing the weighting of the second level value when receiving a blank signal.

23. A protection window signal generator for use in detection of a header region of an optical storage medium, the protection window signal generator comprising:
an adjusting device for adjusting DC level of an RF-sum signal derived from the optical storage medium when the accessing of the optical storage medium is switched from a first area with a first reflectivity to a second area with a second reflectivity so that the resulting RF-sum signal has substantially the same DC level with respect to both the first area and the second area;
a first level extractor coupled to the adjusting device for extracting a maximum level of the adjusted RF-sum signal to generate a corresponding first level value;
a second level extractor coupled to the adjusting device for extracting at least one of a DC level and a bottom level of the adjusted RF-sum signal to generate a corresponding second level value;
a computing device coupled to the first and second level extractors for calculating a reference level according to the first and second level values; and
a comparing device coupled to the computing device and the adjusting device for comparing the adjusted RF-sum signal with the reference level to determine a protection window signal applied to detection of the header region.

24. The protection window signal generator of claim 23, wherein the first area is an area with recorded data and the second area is a blank area.

25. The protection window signal generator of claim 23, wherein the adjusting device adjusts the DC level of the RF-sum signal when receiving a blank signal.

26. The protection window signal generator of claim 23, wherein the adjusting device adjusts the DC level by adjusting the gain or offset of the RF-sum signal.

27. A method for generating a protection window signal for use in detection of a header region of an optical storage medium, the method comprising:
(a) adjusting DC level of an RF-sum signal derived from the optical storage medium when the accessing of the optical storage medium is switched from a first area with a first reflectivity to a second area with a second reflectivity so that the resulting RF-sum signal has substantially the same DC level with respect to both the first area and the second area;
(b) extracting a maximum level of the adjusted RF-sum signal to generate a corresponding first level value;
(c) extracting at least one of a DC level and a bottom level of the adjusted RF-sum signal to generate a corresponding second level value;
(d) calculating a reference level according to the first and second level values; and
(e) comparing the adjusted RF-sum signal with the reference level to determine a protection window signal applied to detection of the header region.

28. The method of claim 27, wherein the first area is an area with recorded data and the second area is a blank area.

29. The method of claim 27, wherein step (a) comprises:
adjusting the DC level of the RF-sum signal when receiving a blank signal.

30. The method of claim 27, wherein step (a) comprises:
adjusting the gain or offset of the RF-sum signal to adjust the DC level.

31. A protection window signal generator for use in detection of a header region of an optical storage medium, the protection window signal generator comprising:
a first level extractor for extracting a maximum level of an RF-sum signal derived from the optical storage medium to generate a corresponding first level value;
a second level extractor for extracting at least one of a DC level and a bottom level of the RF-sum signal to generate a corresponding second level value;
a computing device coupled to the first and second level extractors for calculating a reference level according to the first and second level values;
a comparing device coupled to the computing device and the adjusting device for comparing the RF-sum signal with the reference level to determine a protection window signal applied to detection of the header region; and
means for adjusting at least one of the response speed of the second level extractor, the weighting of the second level value, and the DC level of the RF-sum signal when the accessing of the optical storage medium is switched from a first area with a first reflectivity to a second area with a second reflectivity.

32. A method for generating a protection window signal for use in detection of a header region of an optical storage medium, the method comprising:
extracting a maximum level of an RF-sum signal derived from the optical storage medium to generate a corresponding first level value;
extracting at least one of a DC level and a bottom level of the RF-sum signal to generate a corresponding second level value;
calculating a reference level according to the first and second level values;
comparing the RF-sum signal with the reference level to determine a protection window signal applied to detection of the header region; and
adjusting at least one of the response speed of extracting the DC level/bottom level, the weighting of the second level value, and the DC level of the RF-sum signal when the accessing of the optical storage medium is switched from a first area with a first reflectivity to a second area with a second reflectivity.
